(19) United States
(12) Patent Application Publication
(10) Pub. No.: US 2001/0040949 A1
(43) Pub. Date: Nov. 15, 2001

(54) METHOD AND DEVICE FOR PROVIDING PREPAID 800/900 TELECOMMUNICATIONS SERVICE

(75) Inventors: GREG E. BLONDER, SUMMIT, NJ (US); STEVEN E. GREENSPAN, SCOTCH PLAINS, NJ (US)

Correspondence Address: OLIFF & BERRIDGE,PLC, P. O. BOX 19928, ALEXANDRIA, VA, 22320

(73) Assignee: AT&T Corp.

(21) Appl. No.: 09/219,768

(22) Filed: Dec. 23, 1998

(51) Int. Cl. H04M 15/00; H04M 17/00

(52) U.S. Cl. 379/144.01; 379/112.01; 379/114.01

(57) ABSTRACT

A method and device for providing prepaid 800 and/or 900-type caller services. A caller provides a call request to a telecommunications service provider that can include an 800 or 900 telephone number and an account number for a prepaid account associated with the 800 or 900 telephone number. A determination is made if the prepaid account is authorized for the desired 800 or 900-type call, and if the account is authorized, the caller is connected to the called party associated with the 800 or 900 telephone number. When the call is completed, charges associated with the call are determined and charged to the prepaid account or other party, as desired. The prepaid account is then adjusted to reflect the determined charges.

### BACKGROUND OF THE INVENTION

1. Field of Invention

This invention relates to prepaid 800/900 telecommunications service.

2. Description of Related Art

Prepaid caller services, i.e., prepaid phone cards, are currently provided by telecommunications service providers. These prepaid phone cards are quite useful, especially when making a telephone call at a pay phone, since no actual money is needed to make a telephone call. To use a prepaid phone card, a user typically dials a toll-free access number, and then indicates a desired number to call and an authorization/account number.

However, prepaid calling cards are not used with 800 or 900 calling services. As used herein, an 800 calling service is any calling service for which a caller is typically not charged to call the called party. Instead, the called party is typically automatically charged for 800-type calls. 900 calling services refer to any calling service for which the caller is typically charged on the caller's telephone bill and which typically have a variable rate structure depending on the type of service provided.

### SUMMARY OF THE INVENTION

The invention provides a method and device for providing prepaid caller services for 800 and 900-type calling services. In at least one embodiment of the invention, a telecommunications service provider receives an 800 or 900 call request from a caller using a prepaid account. The call request can include an 800 or 900 telephone number and an account number for a prepaid account. The telecommunications service provider determines if the prepaid account is authorized for the desired 800 or 900 call, and if the account is authorized, the caller is connected to the called party associated with the 800 or 900 telephone number. When the call is completed, charges associated with the call are determined and charged to the prepaid account. The prepaid account is then adjusted to reflect the determined charges. For example, if the prepaid account includes a total currency credit value, the total currency credit value can be decreased an amount associated with the telephone call. The prepaid account can include other credit values that are adjusted, including a total call time, type of call, type of service, etc.

The invention can be useful for 800 calling service subscribers, especially for controlling a total amount spent on an 800 service provided to customers. For example, a company could provide a prepaid 800 calling card or account to purchasers of products sold by the company. The prepaid account could include a credit value that allows each customer a certain number of calls to an 800 number, total call minutes for calling the 800 number, or allow a certain number of calls or call minutes per week for a number of months, for example. Thus, the company could control its total amount spent on 800 calling services to a total dollar value, total call time, total number of calls, or type of calls for each product sold. Prepaid accounts distributed to customers could also be controlled to expire after a certain amount of time has passed after the purchase date, or based on other criteria, such as customer segment, type of product, etc. Thus, the total 800 call service liability for the company can be further controlled.

Prepaid 900 service accounts could likewise be included with the sale of a product or purchased alone. When purchased with a product, the prepaid 900 account could provide access to premium customer services, such as consulting. Prepaid 900 service accounts, or cards, could also be given as a gift. For example, a prepaid 900 service card could be given that provides the owner with a “free” weather report, traffic report, psychic services, crossword puzzle answers, etc., once a week for one month, one year, etc. Thus, the prepaid account, like an 800 prepaid account, could be constructed so that a service can only be accessed a certain number of times, or total amount of time, for each time segment (e.g., one week) of a larger authorization period (e.g., one year).

The prepaid 800 or 900 service accounts can also provide additional services, such as user registration information, that enhance the 800 or 900 service provided. For example, a prepaid 800 card provided with a purchased product could include product registration information, such as a part serial number, product purchase date, etc. Thus, when the prepaid account is used, the registration information can be provided to the called party to speed or enhance the 800 services provided. For example, a customer service center receiving an 800 call from a customer could be provided with a caller's name, product type or number, type of customer service required, etc. Therefore, the customer service representative need not ask, and the caller need not provide during the call, specific information not directly related to the purpose of call.

The 800 or 900 service subscriber can also control how the prepaid accounts are adjusted after each call made using the account. For example, a customer service representative, knowing that the customer's account is about to run out and that the customer will have to call back at a future date, may credit the prepaid account with additional calls, call time or a dollar amount to enable the customer to call the customer service center at a later date. Likewise, a prepaid 900 service account could be debited by the 900 service subscriber according to additional services provided during a 900 call. For example, a charge for faxing or e-mailing a report to a caller could be added to the basic service charges debited to the caller's prepaid 900 account.

These and other aspects of the invention will be apparent or obvious from the detailed discussion below.

### BRIEF DESCRIPTION OF THE DRAWINGS

The invention is described in detail with regard to the following figure, wherein like numerals reference like elements, and wherein:

FIG. 1 is a flowchart of steps of providing prepaid 800 or 900 call services; and

FIG. 2 is a schematic block diagram of a telecommunications network configured in accordance with the invention.

### DETAILED DESCRIPTION OF PREFERRED EMBODIMENTS

As described above, the term “800 call” or “800 call service” is used herein only as a generic reference to communications over a telecommunications network that typically are not charged to the caller. Instead, 800 calls or services are typically automatically charged to an 800 service subscriber, i.e., the called party. Thus, the terms “800 call”, “800 -type call”, “800 call service”, “800 prepaid account”, etc., should not be construed as related only to calls or services associated with an “800 number.” Instead, these terms should be construed as related to any type of call service that is normally not charged to the caller, but rather automatically charged to the called party.

Likewise, the term “900 call” or “900 call service” generically refers to communications over a telecommunications network or related services that are typically charged to the caller's telephone bill and that typically have a variable rate structure determined based on the services (and not only the telecommunications services) provided. Thus, the term “900 call”, “900-type call”, “900 call service”, “900 prepaid account”, etc. should be construed as related to any type of service identical or similar to services associated with “900” telephone numbers, and not just particular calls or services that are associated with a “900 number”.

Although prepaid calling services that allow a caller to prepay for telephone calls exist, such prepaid calling services are typically not used with 800 or 900 calling services. Prepaid cards are typically not used for 800 calling services because this type of call is free to the caller, and therefore no prepaid card need be used. 900 calling services have a variable rate structure and are billed to the caller's telephone bill, and thus, have not been provided in connection with a prepaid account.

However, as discussed above, prepaid accounts for 800 and 900 calling services can be quite useful. For example, prepaid 800 accounts allow an 800 service subscriber to control its 800 calling service liability on a per customer or account basis. Prepaid 900 service accounts can be useful in many ways, including allowing a caller to obtain 900 type services from any phone while having the services debited to a single prepaid account.

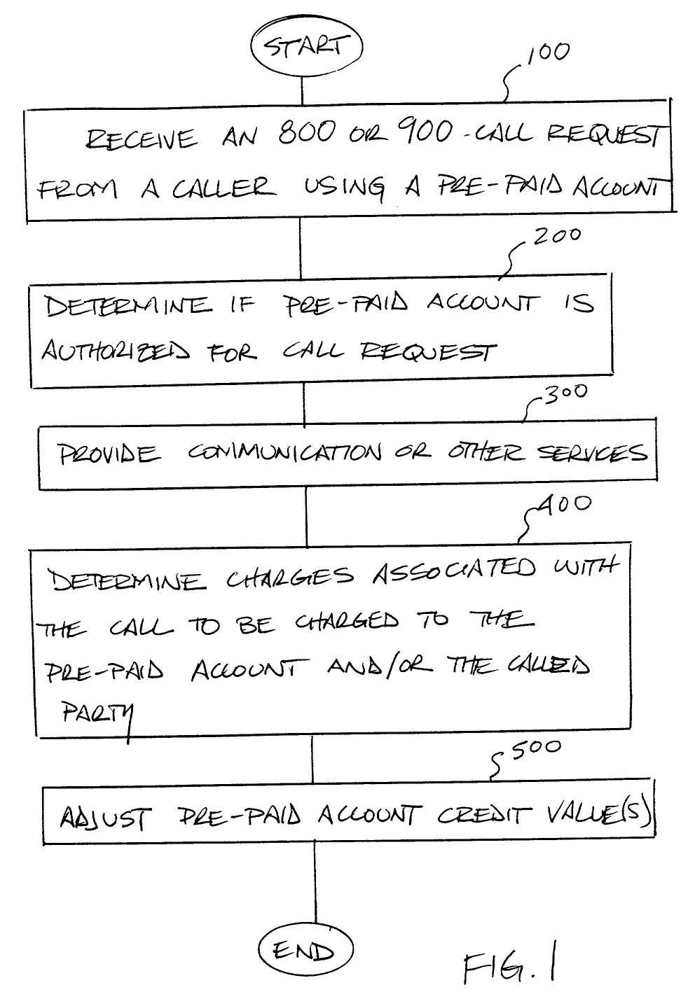

FIG. 1 is a flowchart of steps for providing prepaid 800 or 900 calling services. In step 100, the telecommunications service provider receives an 800 or 900 call request from a caller using a prepaid account. The telecommunications service provider can be a wired or wireless or a combination of wired and wireless communications service provider, such as a telephone and/or cellular network. However, the telecommunications service provider need not be a provider of general communications services, but can be dedicated to providing 800 and/or 900 services. The 800 or 900 call request can be a dialed telephone number and an account number designating a caller's prepaid 800 or 900 account. Thus, the 800 or 900-type number (which can be any string of alphanumeric characters or other symbols) can be first dialed by the caller and recognized by the telecommunications service provider as a number associated with prepaid services. Then, the caller is requested to enter account or other information relating to the prepaid account. However, the call request need not include a telephone number or account number, but can be any signal that designates a party to be called or service obtained and a signal representing a prepaid account. Thus, unlike conventional prepaid card services, the caller need not first dial an access number, and then enter a telephone number for the called party along with prepaid account information. Instead, the caller need only dial the desired 800 or 900 -type number or other signal that represents the called party or desired service and provide prepaid account information to connect with a called party or obtain the desired service.

Typically, a caller will enter a prepaid account number to designate the account, e.g., by pressing a set of appropriate keys on the telephone, but the caller can use a card or other device that is scanned or read by the telephone or other communications device used by the caller. The prepaid card can include, for example, a magnetic strip or other volatile or non-volatile storage medium that stores information such as an account identifier, account credit value (a total dollar amount, number of calls, total call time, caller and/or product identification, etc.) or other information. The information stored in the card can be encrypted or otherwise security protected so that the stored information cannot be tampered with, or if tampered with, the tampering can be detected. The prepaid card or other device can be a passive device having no data processing capability, e.g., a magnetic strip, or can have data processing capability, e.g., can include a microprocessor in addition to a storage device. Thus, an optional way that the caller can make a call request is to “swipe” a prepaid card through a card reader associated with a communications device, which reads an 800 or 900-type number from the card along with account or other information.

In step 200, a determination is made whether the prepaid account is authorized for the caller request. For example, the caller may be attempting to use a prepaid 800 account to make a 900-type call, or may be attempting to access an 800 -type number for which the account is not authorized. That is, the caller may be attempting to telephone company A's 800 service number using a prepaid 800 service account issued by company B. The authorization determination can also involve determining whether the prepaid account has an appropriate amount of credit value to make the requested call. Thus, if the prepaid account only includes a credit value for an extremely short call, or if the account has expired, the prepaid account may not be authorized to be used for the caller request. The authorization determination can also include determining whether the prepaid account can be used for the desired call or service at the particular time of the request. For example, an 800 or 900 prepaid account could be set up so that the caller can only access a particular number or service a certain number of times, or total amount of time, for each time segment (e.g., one week) in a larger authorization period (e.g., one year). To illustrate, a 900 prepaid account could provide a customer with one crossword puzzle answer per week for one year. Thus, the customer could be restricted access to the crossword puzzle answer service once a week for 52 weeks, so that the customer could not access the service twice in any one week of the 52 weeks. Likewise, an 800 prepaid account could be constructed so that a customer could access a customer service number 10 times during a first month, 5 times during a second month, and 5 times over the next 6 months and no more for any given time segment, i.e., month or group of months. As will be appreciated, the prepaid accounts could be constructed in any number of different possible ways, each requiring a different authorization determination.

If the prepaid account is not authorized, the caller can be advised and given the option to add additional credit value to the prepaid account, e.g., by charging a dollar value against an authorized credit card, telephone number, etc. However, the caller need not be advised of the lack of authorization, and instead advised that the call request cannot be honored.

If the prepaid account is authorized, the desired communication or other services are provided in step 300. The services provided in step 300 can be typical telecommunication voice and/or data transmission services, but can include other peripheral services, such as e-mail, messages, database access, etc.

For example, in the 800 call context, the services provided will likely only include voice and/or data transmission services. However, in the 900 call context, and possibly in the 800 call context, other services, such as e-mail or facsimile transmission or other products, such as accessories, software upgrades, etc. may be provided. The services can be provided either by the telecommunications service provider, by the 800 or 900 service subscriber, or another entity.

In step 400, a determination of charges associated with the call is made. The determination can be made as the call is ongoing, or after the call has been terminated. The charges determined can take many forms, including a total dollar amount, an amount of time, a type of call, or other call unit. For example, a caller making an 800 call may be charged one total call for the call, a number of minutes for the call, etc. Charges can also be determined for the called party, such as the 800 or 900 service subscriber in certain cases, or to an entirely different entity if desired. For example, a caller may accept a product upgrade or other product or service in connection with the call, and either the caller or another entity, such as an advertiser, may be charged for the additional product or service received by the caller. Another entity, such as an advertiser, may be charged when the caller receives an additional product or service as part of a product or service promotion. For example, a caller may originally dial an 800-type call, but then agree to accept another service, such as a 900 service, or other product or service as part of a promotional campaign organized by the advertiser.

In addition, charges allocated to the caller's prepaid account can be adjusted by the 800 or 900 service subscriber. For example, an 800 service subscriber may decide to credit a customer's prepaid account with additional call units, a dollar value, number of calls, etc., or choose to not charge the caller's prepaid account at all for a call. The same is true for a 900 service subscriber, e.g., when the caller is not satisfied with the service provided. The 800 or 900 service subscriber can also choose to alter other information associated with a prepaid account, such as extending an expiration date for the account, adding additional authorized services (e.g., 800 or 900-type phone numbers) to the account, etc.

In step 500, once the charges associated with the call have been determined, a prepaid account credit value is adjusted. As discussed above, the prepaid account may include credit values such as a total dollar amount, total number of minutes or calls, or other call units. Thus, the credit value associated with the prepaid account is adjusted to reflect the 800 or 900-type services provided. If the prepaid account is maintained by the telecommunications service provider, a database record or other record corresponding to the prepaid account is updated. If the account information is stored on a card or other device in the caller's possession, the information stored on the card or other device is updated. For example, information stored on a magnetic strip on a prepaid card can be updated or information stored in a memory associated with the card or device is updated.

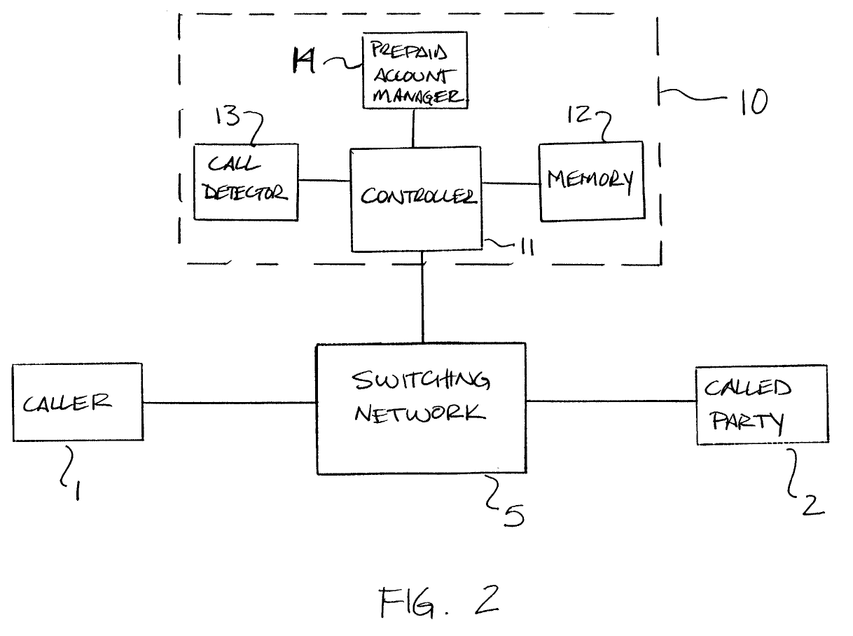

FIG. 2 shows an 800/900 prepaid service device 10 in accordance with the invention. The 800/900 prepaid service device 10 can be incorporated as part of a telecommunications service provider's overall system, or can be provided as a separate unit, e.g., a programmed general purpose computer or network of computers and other associated components. Although in this example embodiment, the 800/900 prepaid service device 10 is capable of providing both 800 and 900 prepaid account services, the 800/900 prepaid service device 10 could be modified to provide only 800 or 900 prepaid account services, if desired.

The 800/900 prepaid service device 10 includes at least one controller 11 that can be implemented, at least in part, as a single special purpose integrated circuit (e.g., ASIC) or an array of ASICs, each having a main or central processor section for overall, system-level control, and separate sections dedicated to performing various different specific computations, functions and other processes under the control of the central processor section. The controller 11 can also be implemented using a plurality of separate dedicated programmable integrated or other electronic circuits or devices, e.g., hardwired electronic or logic circuits such as discrete element circuits or programmable logic devices. The controller 11 also preferably includes other devices, such as volatile or non-volatile memory devices, communications devices, relays, and/or other circuitry or components necessary to perform the desired input/output or other functions.

The 800/900 prepaid service device 10 also includes a memory 12, which can be one or more volatile and/or non-volatile memory devices, such as optical disk, magnetic media, semiconductor or other memory devices.

A call detector 13 and prepaid account manager 14 are also included for detecting 800 or 900-type call requests that are associated with prepaid account services and determining 800 or 900-type call charges and adjusting associated prepaid account information, respectively. The call detector 13 and the prepaid account manager 14 can be implemented as software modules that are executed by the controller 11 or any other suitable data processing apparatus. Alternately, the call detector 13 and the prepaid account manager 14 can be implemented as hard-wired electronic circuits or other programmed integrated or other electronic circuits or devices, e.g., hardwired electronic or logic circuits such as discrete element circuits or programmable logic devices.

When a caller 1 places an 800 or 900-type call to a called party 2, the call detector 13 detects whether the call is one that is associated with prepaid account services. The 800 or 900-type call request is placed by the caller using a telephone or other communications device linked to a telecommunications switching network 5, as is well known in the art. The call detector 13 detects whether a call is associated with prepaid account services by comparing a number dialed by the caller 1 with a database of prepaid account information stored in the memory 12. If the number dialed by the caller 1 matches a record in the database, the call detector 13 indicates that the call is associated with prepaid account services. In response, the controller 11 prompts the caller 1, or requests the switching network to prompt the caller 1, to provide account information. Alternately, the called number and prepaid account information can be provided together from the caller 1 without prompting from the controller 11, e.g., by having a prepaid card read for the information, which is provided to the 800/900 prepaid service device 10.

When prepaid account information is received, the prepaid account manager 14 determines if the account is authorized for the call requested. As discussed above, the prepaid account manager can access appropriate prepaid account information stored in the memory 12 and determine whether the prepaid account has an appropriate amount of credit value to make the requested call, or make another determination regarding authorization. Thus, if the prepaid account only includes a credit value for an extremely short call, if the account has expired, or if the account has not expired, but cannot be used for the particular service requested, the prepaid account may not be authorized. If the prepaid account is not authorized, the caller 1 can be advised and given the option to add additional credit value to the prepaid account, e.g., by charging a dollar value against an authorized credit card, telephone number, etc. If the caller 1 chooses to add additional credit to the prepaid account, the prepaid account manager 14 bills the appropriate credit card, telephone number, etc. and updates the prepaid account information in the memory 12. However, the caller 1 need not be advised of the lack of authorization, and simply be advised that the call request cannot be honored.

If the caller's prepaid account is authorized for the requested call, 800/900 prepaid service device 10 instructs the switching network 5 to connect the caller 1 and the called party 2. The prepaid account manager 14 can provide information related to the call, such as customer identification, purchased product identification, type of call (e.g., service, complaint, product information request, etc.) or other information to the called party 2. This information is preferably stored in the memory 12 and sent to the called party 2 over the same line used to interconnect the caller 1 and called party 2. However, the information can be provided to the called party 2 in other ways, such as over a separate line or connection. The information provided to the called party 2 can be gathered when the caller 1 first uses the prepaid account, e.g., an operator can ask the caller 1 for the information and enter the desired information into the memory 12. Alternately, the information can be provided as electronic data from the called party 2 or other entities, e.g., using an Internet-based customer registration system, and loaded into the memory 12.

Any billing operations normally performed by the switching network 5 are suspended when a prepaid 800 or 900-type call is made by the caller 1 to the called party 2. That is, whereas an 800 or 900-type call placed using the switching network 5 would normally be billed by appropriate elements of the switching network 5 to the 800 subscriber or the caller's 1 telephone bill, when a prepaid 800 or 900-type call is made, the switching network 5 does not perform its normal billing operations.

Instead, the 800/900 prepaid service device 10 determines charges for the call. For example, the prepaid account manager 14 could request the appropriate devices in the switching network 5 to generate billing information in a standard fashion and provide the information to the prepaid account manager 14, which then manages the billing for the call. Preferably, the prepaid account manager 14 begins determining charges associated with the call as the call is ongoing. Thus, the prepaid account manager 14 could compare the charges associated with the call to a call credit amount in the caller's prepaid account during the call. If the credit amount drops below a threshold, the prepaid account manager 14 could terminate the call, provide a message that the call is about to be terminated, switch billing of the call to normal billing operations of the switching network 5 when the prepaid account credit value runs out, etc. Alternately, the prepaid account manager 14 could determine the charges for the call after the call has been completed.

The charges associated with the call can also be adjusted by the 800 or 900 service subscriber, i.e., the called party 2. For example, a called party 2 providing 800 services may decide to credit a customer's prepaid account with additional call units, a dollar value, number of calls, etc., or choose to not charge the caller's prepaid account at all for a call. The same is true for a called party 2 that is a 900 service subscriber. The called party 2 can also choose to alter other information associated with a prepaid account, such as extending an expiration date for the account, adding additional authorized services (e.g., 800 or 900 phone numbers) to the account, etc. Adjustments to the caller's 1 prepaid account can be made by the called party 2 entering a key or set of keys on a communication device that are received and recognized by the prepaid account manager 14. Alternately, the called party 2 could give voice instructions to alter the prepaid account that are acted on by a prepaid account service operator, i.e., a person, that enters the updated information into the database in the memory 12. Thus, charges unrelated to the call telecommunication services, such as charges for products provided to the caller 1, can also be added to the total charges. For example, a caller 1 could choose to purchase a product during a 900-type call and have the purchase price of the product deducted from the prepaid account.

Once the call is terminated, either by the caller 1 and/or the called party 2 hanging up or by the prepaid account manager 14 terminating the call due to a lack of credit value in the prepaid account, the prepaid account manager 14 adjusts the prepaid account credit value(s) according to the charges determined for the call. As discussed above, the credit value(s) adjusted can represent a total dollar value, number of calls, number of types of calls, or other call units. Other adjustments to the prepaid account can also be made, such as expiration date information, customer identification, product identification, etc.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. A method for providing prepaid 800 or 900-type calling services, comprising:
receiving an 800 or 900-type call request from a caller using a prepaid account;
determining if the caller's prepaid account is authorized for the call request;
authorizing the desired communication or other services in connection with the call request;
determining charges associated with the communication or other services provided in connection with the call request; and
adjusting a credit value of the caller's prepaid account in accordance with the determined charges.

2. The method of claim 1, wherein the step of receiving an 800 or 900-type call request comprises:
receiving a signal representing an 800 or 900 telephone number; and
receiving a signal representing the caller's prepaid account.

3. The method of claim 1, wherein the step of determining if the caller's prepaid account is authorized comprises:
accessing stored information corresponding to the prepaid account; and
determining if the prepaid account properly corresponds to the call request.

4. The method of claim 1, wherein the step of authorizing communication or other services comprises:
authorizing telecommunication services for an 800 or 900 telephone call.

5. The method of claim 1, wherein the step of authorizing communication or other services comprises:
providing an 800 or 900 service subscriber corresponding to the call request with information including at least one of a prepaid account expiration date, a product identifier, a call category, caller identification information, a product purchase date, caller service history, and a current prepaid account credit value.

6. The method of claim 1, wherein the step of determining charges associated with the communication or other services provided comprises:
determining a length of time of the 800 or 900-type call.

7. The method of claim 1, wherein the step of determining charges associated with the communication or other services provided comprises:
receiving information from the 800 or 900 service subscriber regarding services provided to the caller.

8. The method of claim 1, wherein the step of determining charges associated with communication or other services provided comprises:
receiving information from the 800 or 900 service subscriber representing an adjustment amount of a credit value for the caller's prepaid account.

9. The method of claim 1, wherein the step of determining charges associated with the communication or other services provided comprises:
determining an amount to charge the 800 or 900 service subscriber for services provided in connection with the 800 or 900-type call request.

10. The method of claim 1, wherein the step of determining charges associated with the communication or other services provided comprises:
determining an amount to charge an entity other than the caller and the 800 or 900 service subscriber.

11. The method of claim 1, wherein the step of adjusting a credit value for the caller's prepaid account comprises:
adjusting a credit value amount representing at least one of a total currency amount, a total length of time, a type of call, a number of calls, a number of calls or call time for a time segment that is part of a larger authorization period, and an expiration date.

12. The method of claim 1, wherein the step of adjusting a credit value for the caller's prepaid account comprises:
adjusting information maintained by a telecommunications service provider.

13. The method of claim 1, wherein the step of adjusting a credit value for the caller's prepaid account comprises:
adjusting information stored on a hand-held storage device storing information regarding the caller's prepaid account.

14. An 800/900 prepaid service device associated with a telecommunications switching network that receives an 800 or 900-type call request from a caller representing a call to be made to a called party using a caller's prepaid account, the 800/900 prepaid service device comprising:
a call detector that detects that the call request represents an 800 or 900-type call associated with prepaid call services;
a prepaid account manager that determines if the caller's prepaid account is authorized for the call request, determines charges associated with communication or other services provided if the caller's prepaid account is authorized, and adjusts a credit value of the caller's prepaid account in accordance with the determined charges; and
a memory that stores information associated with the caller's prepaid account.

15. The 800/900 prepaid service device of claim 14, wherein the call detector detects a signal representing an 800 or 900 telephone number.

16. The 800/900 prepaid service device of claim 14, wherein the prepaid account manager accesses information stored in the memory corresponding to the caller's prepaid account and determines if the prepaid account properly corresponds to an 800 or 900 telephone number detected by the call detector.

17. The 800/900 prepaid service device of claim 14, wherein the prepaid account manager authorizes a telecommunications switching network to provide telecommunication services for the 800 or 900 telephone call.

18. The 800/900 prepaid service device of claim 14, wherein the prepaid account manager provides the called party with information including at least one of a prepaid account expiration date, a product identifier, a call category, caller identification information, a product purchase date, caller service history, and a current prepaid account credit value.

19. The 800/900 prepaid service device of claim 14, wherein the prepaid account manager receives information from the called party regarding services provided to the caller and uses the information to determine charges for the call.

20. The 800/900 prepaid service device of claim 14, wherein the prepaid account manager adjusts a credit value amount of the caller's prepaid account representing at least one of a total currency amount, a total length of time, a type of call, a number of calls, a number of calls or call time for a time segment that is part of a larger authorization period, and an expiration date.

21. The 800/900 prepaid service device of claim 14, wherein the memory comprises:
a first memory device that stores information regarding 800 and 900 telephone numbers associated with caller prepaid accounts; and
a second hand-held memory device storing information regarding the caller's prepaid account.
